(19) United States
(12) Patent Application Publication
(10) Pub. No.: US 2006/0290625 A1
(43) Pub. Date: Dec. 28, 2006

(54) Light source device and projection type display device

(75) Inventor: Naoya Sugimoto, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/452,652

(22) Filed: Jun. 14, 2006

(30) Foreign Application Priority Data
Jun. 24, 2005 (JP) 2005-184928

(51) Int. Cl. G09G 3/32

(52) U.S. Cl. 345/83

(57) ABSTRACT

There is provided light source device comprising; a plurality of light source sections, a control section, and a light amount monitoring section, wherein the control section gradually increases a voltage value applied to the light source sections from a low voltage value, the light amount monitoring section obtains a voltage value at a time when it is detected that a predetermined illumination light amount has started to be irradiated, and obtains a voltage setting value based on this voltage value, and the control section applies a voltage of this voltage setting value to the plurality of light sources.

### BACKGROUND OF THE INVENTION

1. Field of the Invention

The present invention relates to a light source device used in a projector for displaying an image on a projection surface, and in particular to power supply voltage settings in the case where an LED (Light Emitting Diode) is used as a light source.

This application is based on Japanese Patent Application No. 2005-184928, the content of which is incorporated herein by reference.

2. Description of Related Art

In recent years, in a small projector, a spatial light modulation element such as a DMD (Digital Micromirror Device) element that modulates illumination light by switching minute mirrors of respective pixels arranged in a matrix, to angles of ON and OFF status at high speed according to image data, has come into use.

Since a spatial light modulation element differs from a conventional liquid crystal display element and enables high speed operation, images of R (red), G (green) and B (blue) can be displayed in a frame sequential mode. Moreover, whereas a projector using a liquid crystal display element requires three LCD (Liquid Crystal Display) elements for displaying a color image, a projector that uses a spatial light modulation element can carry out color display with one DMD element.

In a projector that uses such a spatial light modulation element, a white light lamp is conventionally used as a light source. That is to say, in a projector that uses a conventional spatial light modulation element, an input image signal is converted into a frame sequential image signal and supplied to the spatial light modulation element, and a colored wheel colored in RGB is rotated in synchronization with the vertical synchronization signal of the input image, to irradiate the light from the lamp on the spatial light modulation element through the colored wheel. However, when a lamp is used as a light source of a projector, power consumption becomes significant, and also a colored wheel is required.

On the other hand, use of an LED as a light source for such a projector has been considered in recent years. Compared with a lamp, an LED has the advantages of smaller size, greater durability, longer operating life, and lower power consumption. Moreover, when R (red), G(green), and B(blue) three colored LEDs are used, the colored wheel is no longer required, and excellent color characteristics can be achieved. Furthermore, in the case where the spatial light modulation element is used, since it does not have the polarization dependence that is observed in a liquid crystal display element, an optical system with a small loss with respect to a light source that emits non-polarized light, such as an LED, can be easily configured.

An LED driving circuit that can be used in a projector using an LED as a light source is, for example, disclosed in Japanese Unexamined Patent Application, First Publication No. 2004-311460, Japanese Unexamined Patent Application, First Publication No. 2004-311635, and Japanese Unexamined Patent Application, First Publication No. 2002-244619.

In the LED driving circuit disclosed in Japanese Unexamined Patent Application, First Publication No. 2004-311460, a driving voltage of an LED of each color is stored in an application voltage storage register, and the LEDs of each color are driven with separate driving voltages to reduce power consumption.

The LED driving circuit disclosed in Japanese Unexamined Patent Application, First Publication No. 2004-311635 comprises; a driving device that drives LEDs while temporally switching driving conditions, with a load driving circuit that supplies a voltage and a current for driving a load, an LED switching switch that switches load under which the load driving circuit drives, and an LED lighting controller that obtains, before switching, LED characteristics information of after the LED switching switch has performed switching, and that sets a voltage and a current according to the LED characteristics information of after the load driving circuit has switched the LED driving voltage and current, in synchrony with switching timing.

The LED driving circuit disclosed in Japanese Unexamined Patent Application, First Publication No. 2002-244619, is a driving circuit of an LED display device having pixels configured with a plurality of LEDs of mutually different colors, in which the LED display device has a common driver connected to the plurality of LEDs, a first switching device for switching and supplying the voltage from a power supply to the LED of each light emission color among the plurality of LEDs in sequence, and a second switching device for switching and supplying image data for each light emission color to the driver in synchronization with the switching operation of the first switching device.

In the case where the LEDs are driven with a constant current circuit, power is supplied to the LEDs from a constant voltage power supply, and this power supply is driven with a constant current. a LED has a unique forward voltage Vf. Therefore, the output voltage of the constant voltage circuit needs to be set higher than the forward voltage Vf. However, when the output voltage of the constant voltage circuit is too high, the portion of voltage above the forward voltage Vf is consumed unnecessarily. Consequently, when the output voltage of the constant voltage circuit is made too high, there are problems of large power consumption and large heat generation. Therefore, it is preferable for the output voltage of the constant voltage circuit to be set slightly above the forward voltage Vf of the LED. The forward voltage Vf of the LED has variation for each color and for each individual LED. Therefore, in order to ideally set the voltage of the constant voltage circuit, the output voltage of the constant circuit needs to be set in consideration of variations for each color and for each individual LED.

Japanese Unexamined Patent Application, First Publication Nos. 2004-311460, 2004-311635, and 2002-244619, describe driving LEDs with a constant current, however, they do not discuss optimization of a voltage of the constant voltage circuit.

### BRIEF SUMMARY OF THE INVENTION

In consideration of the problems described above, an object of the present invention is to provide a light source device and a projection type display device in which a voltage to be given to an LED driving circuit can be optimally set according to variation in each color and in the characteristics of each individual LED.

The present invention provides a light source device comprising; a plurality of light source sections that output illumination light, a control section that controls voltage values applied to the plurality of light source sections, and a light amount monitoring section that detects and monitors whether or not a predetermined illumination light amount is being irradiated from the plurality of light source sections, wherein the control section gradually increases a voltage value applied to the light source sections from a low voltage value, or gradually decreases a voltage value applied to the light source sections from a high voltage value, the light amount monitoring section obtains a voltage value at a time when it is detected that a predetermined illumination light amount has started to be irradiated, or at a time when it is detected that a predetermined illumination light amount has ceased to be received, and obtains a voltage setting value based on this voltage value, and the control section applies a voltage of this voltage setting value to the plurality of light sources.

In the above light source device, the plurality of light source sections may comprise a plurality of LEDs.

In the above light source device, the light amount monitoring section may separately find the voltage setting values for each of the plurality of light source sections, and the control section may control voltage values to be respectively applied to the plurality of light source sections at the separately found voltage setting values.

In the above light source device, the plurality of LEDs may have different respective forward voltage characteristics, and the light amount monitoring section may take LEDs having substantially the same forward voltage characteristics to be a group, and find the voltage setting value for each group, and the control section may control a voltage value to be applied to the plurality of LEDs based on the voltage setting values found for each group.

In the above light source device, each of the illumination lights irradiated from the plurality of light source sections may have a plurality of colors, and the light amount monitoring section may find the voltage setting value for groups of light source sections having a same color of the irradiated illumination light, and the control section may control a voltage value to be applied to the plurality of light source sections with the voltage setting values found for each group.

The above light source device may further have a memory section for storing the voltage setting values, and, in operation, the control section may supply a voltage of the voltage setting value read from the memory section to the plurality of light sources.

In the above light source device, the light amount monitoring section may have a sensor for detecting a light amount value of the illumination light irradiated from the plurality of light source sections, and, based on a light amount value detected by this sensor, the light source section may detect whether or not a predetermined illumination light amount has started to be irradiated.

In the above light source device, the sensor may have sensitivity characteristics similar to a relative luminous efficiency of a human being, and may have a current-voltage conversion circuit for converting a detected light amount value into a voltage value, and an amplification factor of the current-voltage conversion circuit may change according to a light emission color from the light source sections.

In the above light source device, a voltage of the light source sections may be controlled based on a voltage value converted from a light amount value detected by the sensor.

In the above light source device, the light amount monitoring section may have a second memory section for storing a relationship between a current value applied to the light source sections, and an illumination light amount irradiated from the light source sections, and may estimate an illumination light amount corresponding to a detected current value applied to the light source sections, based on the relationship stored in the second memory section.

The above light source device may further have a synthesizing optical section that synthesizes illumination lights irradiated from the plurality of light source sections into one illumination light, and the light amount monitoring section may detect whether or not a predetermined illumination light amount has started to be irradiated, based on the light amount of the synthesized illumination light.

The light source device of the present invention is particularly suitable for application in a projection type display device. In the case where the light source device of the present invention is used for a projection type display device, the projection type display device may have the additional constituents of a spatial modulation section, and a projection optical section, as well as the above light source device.

Other than in a projector that uses LEDs for light sources, the present invention can be used in a device that drives LEDs with a required light amount or required current.

According to the present invention, an LED driving current or LED light amount is observed while the voltage value of the constant voltage circuit applied to the LED is gradually raised from a low voltage value, and the voltage value at the time when it is detected that a predetermined illumination light amount has started to be irradiated is found and taken as the voltage setting value. Moreover, the LED is driven by applying the voltage of this voltage setting value to the LED as an output voltage of the constant voltage circuit. As a result, the voltage to be applied to the LED driving circuit can be optimally set in response to variations in LED characteristics of each color or individual LEDs.

### BRIEF DESCRIPTION OF THE SEVERAL VIEWS OF THE DRAWINGS

FIG. 1 is a block diagram showing one example of a projector that uses a rotating optical system to which the present invention can be applied.

FIG. 2 is an explanatory diagram of the rotating optical system in a projector that uses the rotating optical system to which the present invention can be applied.

FIG. 3 is a block diagram showing a first example of a power supply control circuit in a projector that uses a rotating optical system to which the present invention can be applied.

FIG. 4 is a graph for describing differences in forward voltage characteristics of LEDs of different light emission colors.

FIG. 5 is a graph for describing differences in forward voltage characteristics of LEDs within the same color.

FIG. 6 is a graph for describing differences in light amount characteristics of LEDs within the same color.

FIG. 7 is a flow chart used for describing a first example of power supply voltage control.

FIG. 8 is a flow chart used for describing a second example of power supply voltage control.

FIG. 9 is a timing diagram used for describing power supply voltage control.

FIG. 10 is a block diagram showing a second example of a power supply control circuit in a projector that uses a rotating optical system to which the present invention can be applied.

FIG. 11 is a graph used for describing sensitivity characteristics of a photosensor.

FIG. 12 is a flow chart used for describing a third example of the power supply voltage control.

FIG. 13 is a flow chart used for describing a fourth example of the power supply voltage control.

FIG. 14 is a block diagram used for describing voltage control by data.

FIG. 15 is an explanatory diagram in the case of performing voltage control by data.

FIG. 16 is an explanatory diagram in the case of performing the voltage control by data.

FIG. 17 is a block diagram used for describing gain control by data.

FIG. 18 is a block diagram showing a third example of a power supply control circuit in a projector that uses a rotating optical system to which the present invention can be applied.

FIG. 19 is a block diagram showing one example of a projector that uses a fixed illumination method to which the present invention can be applied.

FIG. 20 is a block diagram showing a first example of a power supply control circuit in a projector that uses a fixed illumination method to which the present invention can be applied.

FIG. 21 is a block diagram showing a second example of a power supply control circuit in a projector that uses a fixed illumination method to which the present invention can be applied.

FIG. 22 is a block diagram showing a third example of a power supply control circuit in a projector that uses a fixed illumination method to which the present invention can be applied.

### DETAILED DESCRIPTION OF THE INVENTION

Hereinafter, embodiments of the present invention are described, with reference to the drawings. The present invention is used for a light source device in a projector that uses LEDs as a light source.

1. Configuration of a Projector that Uses a Rotating Optical System

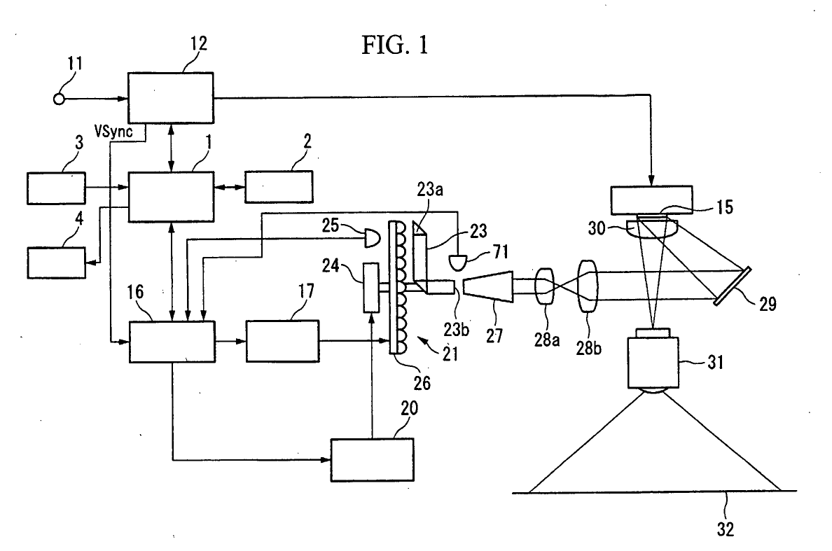

FIG. 1 shows an overall configuration of a projector that uses a rotating optical system to which the present invention can be applied. In FIG. 1, a control circuit 1 comprising a CPU (Central Processing Unit) and so forth, controls the overall operations of the projector. For the control circuit 1 is connected to a memory 2, an input section 3, and a display section 4.

The input section 3 notifies the control circuit 1 of externally inputted information such as operator operation information, and includes an operation panel, a remote controller, and so forth for performing various kinds of setting. The display section 4 notifies external sections regarding the status of circuits in the device using an LED indicator and the like, according to instructions from the control circuit 1.

An image signal is supplied to an input terminal 11. The image signal from the input terminal 11 is transmitted to a DMD drive control circuit 12. The DMD drive control circuit 12 performs video signal processing such as sync separation, YC separation, IP conversion, resolution conversion, color conversion, and trapezoidal correction, for various kinds of input video signals according to the formats thereof. Here, the YC separation refers to a processing that separates a luminance signal and chrominance signal. The IP conversion is a conversion from interlace scanning into progressive scanning. The DMD drive control circuit 12 performs conversion processing for a field frequency of the input image signal to prevent color shift, and it further forms an RGB frame sequential image signal based on the input image signal. This frame sequential image signal is supplied as a DMD driving signal to a DMD element 15.

The DMD element 15 is a spatial light modulation element that has a number of minute mirrors disposed on the surface thereof, the angles of the mirrors being changeable with respect to each pixel. When the DMD driving signal from the DMD drive control circuit 12 is given to the DMD element 15, the angles of the minute mirrors on the surface of the DMD element 15 change, thereby changing the path of the light to perform ON/OFF of the light for each pixel.

Moreover, a vertical synchronization signal VSync that has been separated in the DMD drive control circuit 12.is supplied to a timing generation circuit 16. The timing generation circuit 16 generates an LED driving pulse. This LED driving pulse is supplied to an LED driving circuit 17. A driving current is allowed to sequentially flow to a plurality of LEDs 22r, 22g, and 22b disposed on the rotating optical system 21 by the LED driving circuit 17. As a result, the plurality of LEDs 22r, 22g, and 22b light in sequence based on the vertical synchronization signal of the input image signal.

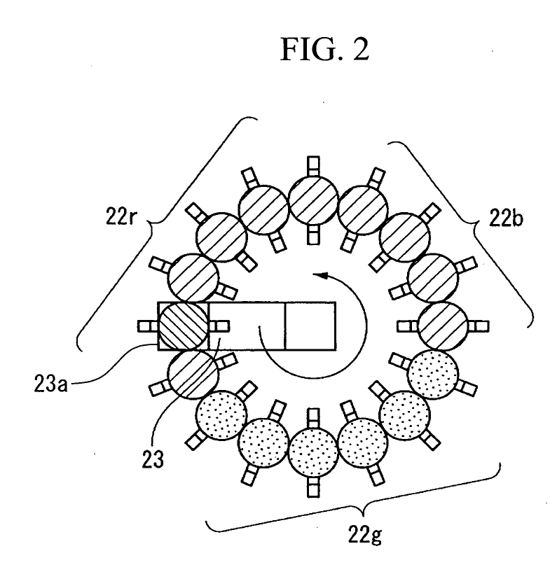

As shown in FIG. 2, the rotating optical system 21 is configured with; an LED substrate 26 with a plurality of red color LEDs 22r, a plurality of green color LEDs 22g, and a plurality of blue color LEDs 22b mounted and arranged in a circle, a rotating rod 23, and a motor 24. this rotating rod 23 is provided opposing to the plurality of the LEDs 22r, 22g, and 22b arranged in a circle, and is rotated by the motor 24.

In FIG. 1, the timing generation circuit 16 generates a motor driving signal. This motor driving signal is supplied to a motor driving circuit 20. As a result, the motor 24 rotates and the rotating rod 23 is rotated.

The rotation of the rotating rod 23 is detected by the rotation detection sensor 25. A rotation detection signal from this rotation detection sensor 25 is supplied to the timing generation circuit 16. The rotation detection signal from the rotation detection sensor 25 is compared with the vertical synchronization signal of the input image signal in the timing generation circuit 16, and the motor driving signal is generated based on the comparison signal. Thus, rotation of the motor 24 is controlled to synchronize with the vertical synchronization signal of the input image signal, so that a required number of revolutions is achieved.

As a result of rotation of the motor 24, an input end 23a of the rotating rod 23 rotates above and along the plurality of LEDs 22r, 22g, and 22b arranged in a circle. Due to the rotation of the rotating rod 23, among the plurality of LEDs 22r, 22g, and 22b, the light of the LED present in a position corresponding to the position of the input end 23a of the rotating rod 23 is selectively taken in, and this light is guided out from the output end 23b of the rotating rod 23. Moreover, the light amount of the synthesized light of the LEDs 22r, 22g, and 22b is detected by a photosensor 71, and this light amount detection signal is supplied to the timing generation circuit 16.

The light from the rotating rod 23 is incident on a light beam shape conversion element 27. The light output from the output end of the light beam shape conversion element 27 travels through an illumination optical system comprising illumination lenses 28a and 28b, a mirror 29, and a field lens 30, and it is then irradiated onto the surface of the DMD element 15 on which the minute mirrors are formed.

The angles of the minute mirrors on the surface of the DMD element 15 are changed by the DMD driving signal, thereby changing the path of the light. Therefore, the reflected light of the DMD element 15 is modulated by the DMD driving signal from the DMD drive control circuit 12 for each pixel. The light modulated by this DMD driving signal is magnified as projection light via a projection lens 31, and is projected on a projection surface 32. As a result, an image is projected on the projection surface 32.

As described above, in the rotating optical system 21, the plurality of RGB LEDs 22r, 22g, and 22b is arranged in a circle, and the rotating rod 23 that rotates along the plurality of LEDs 22r, 22g, and 22b is provided. The plurality of LEDs 22r, 22g, and 22b is sequentially pulse driven, and the plurality of LEDs 22r, 22g, and 22b is sequentially pulse lit. Moreover the rotating rod 23 rotates in synchronization with the LEDs 22r, 22g, and 22b, and the light of the lighting LEDs 22r, 22g, and 22b is irradiated towards the spatial light modulation element.

There is a limit to the current that can be applied to the LED when the LED is direct current driven. However, when the rotating optical system 21 is used, the LED is pulse driven as mentioned above. As a result, high current can be applied to the LED and intense light emission can be achieved. Also, when such a rotating optical system is used, the light of the LEDs while lit is collected by the rotating rod 23 of the optical system 21. Therefore it is equivalent to a continuous lighting of the LEDs.

2. First Example of a Power Supply Control Circuit of a Projector that Uses a Rotating Optical System.

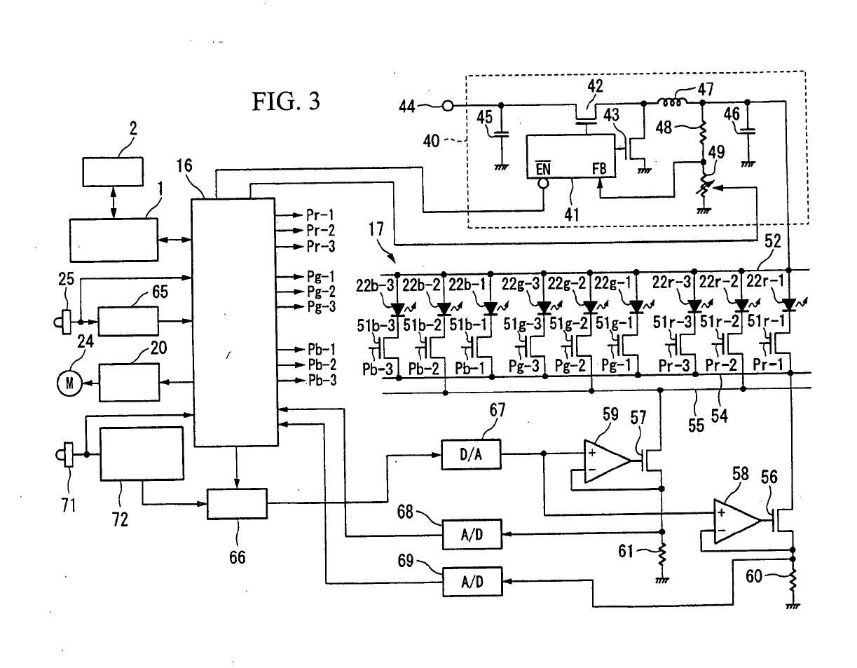

The present invention is used for a power supply control of an LED driving circuit 17 in a projector that uses the rotating optical system 21 described above. FIG. 3 shows one example of a configuration of the power supply control circuit of the LED driving circuit 17 to which the present invention is applied.

In FIG. 3, a power supply circuit 40 is a constant voltage power supply circuit that comprises a DC-DC control circuit 41. Direct current power is supplied to an input terminal 44, and the power supply from the input terminal 44 is switching controlled to a required voltage by the switching operation of a FET 42 and a FET 43, and is then transmitted to a power supply line 52.

Capacitors 45 and 46, and a choke coil 47 are for ripple removal. The output voltage of the power supply circuit 40 is detected from a connection point between a resistor 48 and a digital potentiometer 49, and is supplied to a feedback terminal FB of the DC-DC control circuit 41. The DC-DC control circuit 41 switches the FET 42 and the FET 43 based on the feedback voltage transmitted to this feedback terminal FB to control the output voltage to the required voltage. The output voltage of the power supply circuit 40 can be changed by a setting value of the digital potentiometer 49.

Moreover, an enable signal from the timing generation circuit 16 is supplied to an enable terminal EN of the DC-DC control circuit 41. When this enable signal reaches L level, the status of the DC-DC control circuit 41 becomes operational.

The red color LEDs 22r (22r-1, 22r-2, 22r-3), the green color LEDs 22g (22g-1, 22g-2, 22g-3), and the blue color LEDs 22b (22b-1, 22b-2, 22b-3) are arranged in a circle as shown in FIG. 2. In the following description, a case where the red color LEDs 22r, the green color LEDs 22g, and the blue color LEDs 22b are respectively configured with 3 LEDs, is described as an example. The number of LEDs to be installed in the present invention is not limited to this example. Also the number of LEDs to be installed can be altered according to color.

FETs 51r (51r-1, 51r-2, 51r-3), 51g (51g-1, 51g-2, 51g-3), and 51b (51b-1, 51b-2, 51b-3) for switching each LED are respectively provided for switching each of the LEDs 22r (22r-1, 22r-2, 22r-3), the LEDs 22g (22g-1, 22g-2, 22g-3), and the LEDs 22b (22b-1, 22b-2, 22b-3).

Anodes of the LEDs 22r (22r-1, 22r-2, 22r-3), the LEDs 22g (22g-1, 22g-2, 22g-3), and the LEDs 22b (22b-1, 22b-2, 22b-3) are connected to a power supply line 52. Cathodes of the LEDs 22r (22r-1, 22r-2, 22r-3), the LEDs 22g (22g-1, 22g-2, 22g-3), and the LEDs 22b (22b-1, 22b-2, 22b-3) are respectively connected to drains of the FETs 51r (51r-1, 51r-2, 51r-3), 51g (51g-1, 51g-2, 51g-3), and 51b (51b-1, 51b-2, 51b-3).

Lighting pulses Pr (Pr-1, Pr-2, Pr-3), Pg (Pg-1, Pg-2, Pg-3), and Pb (Pb-1, Pb-2, Pb-3) from the timing generation circuit 16 are respectively supplied to each of the gates of the FETs 51r (51r-1, 51r-2, 51r-3), 51g (51g-1, 51g-2, 51g-3), and 51b (51b-1, 51b-2, 51b-3). Sources of the alternate FETs 51r (51r-1, 51r-3), 51g (51g-1, 51g-3), and 51b (51b-1, 5lb-3) are connected to a line 54, and sources of the other alternate FETs 51r (51r-2), 51g (51g-2), and 51b (51b-2) are connected to a line 55.

The drain of an FET 56 is connected to the line 54. The source of the FET 56 is connected to an inverting input terminal of an operational amplifier 58, and a resistor 60 is connected between the source of the FET 60 and ground.

The drain of an FET 57 is connected to the line 55. The source of the FET 57 is connected to an inverting input terminal of an operational amplifier 59, and a resistor 61 is connected between the source of the FET 57 and ground.

The rotation detection signal from the rotation detection sensor 25 is supplied to a PLL circuit 65. The PLL circuit 65 generates a reference clock based on the rotation detection signal from the rotation detection sensor 25. This reference clock is supplied to the timing generation circuit 16. The timing generation circuit 16 generates the lighting pulses Pr (Pr-1, Pr-2, Pr-3), Pg (Pg-1, Pg-2, Pg-3), and Pb (Pb-1, Pb-2, Pb-3) based on this reference clock.

Moreover, a ROM 66 stores data of the current values of the respective LEDs. The current value setting data is read from ROM 66 in synchrony with the light emitting timing of the respective colored LEDs. This current value setting data is supplied to a D/A converter 67, and is converted into a set voltage of the electric current value by the D/A converter 67. This set voltage of the electric current value is supplied to a non-inverting input terminal of the operational amplifiers 58 and 59.

Furthermore, the photosensor 71 monitors the light amount of the LED. This light amount detection signal is supplied to a correction data generation circuit 72. The correction data generation circuit 72 generates correction data, and this correction data is supplied to the ROM 66. As a result, setting data is corrected according to the light amount of the LED.

The timing generation circuit 16 outputs lighting pulses Pr (Pr-1, Pr-2, Pr-3), Pg (Pg-1, Pg-2, Pg-3), and Pb (Pb-1, Pb-2, Pb-3) that sequentially become H level. For example, the FET 51r-1 is turned on as the lighting pulse Pr-1 becomes H level in the light emitting period of each of the LEDs. As a result, current flows to the LED 22r-1, and the LED 22r-1 lights.

At this time, the current flowing to the LED 22r-1 is determined by the current flowing through the FET 56. A set voltage based on the current value setting data read from the ROM 66 is supplied to the non-inverting input terminal of the operational amplifier 58. The output voltage of the operational amplifier 58 is applied to the gate of the FET 56, and the source voltage of the FET 56 is fed-back to the inverting input terminal of the operational amplifier 58. Therefore, a voltage based on the current value setting data from the ROM 66 is applied to the gate of the FET 56, and the desired current flows to the FET 56. As a result, the LED 22r-1 can be driven with the required constant current.

Next, the FET 51r-2 is turned on as the lighting pulse Pr-2 becomes H level. As a result, current flows to the LED 22r-2, and the LED 22r-2 lights. At this time, the current flowing to the LED 22r-2 is determined by the current flowing through the FET 57. A set voltage based on the current value setting data read from the ROM 66 is supplied to the non-inverting input terminal of the operational amplifier 59. The output voltage of the operational amplifier 59 is applied to the gate of the FET 57, and the source voltage of the FET 57 is fed-back to the inverting input terminal of the operational amplifier 59. Therefore, a voltage based on the current value setting data from the ROM 66 is applied to the gate of the FET 57, and the desired current flows to the FET 57. As a result, the LED 22r-2 can be driven with the required constant current.

Driving currents set by the FET 56 and FET 57 are detected from the voltages of the resistor 60 and the resistor 61, and these detected values are digitized in an A/D converter 68 and an A/D converter 69 and transmitted to the timing generation circuit 16.

Thereafter, when the lighting pulses Pr (Pr-1, Pr-2, Pr-3), Pg (Pg-1, Pg-2, Pg-3), and Pb (Pb-1, Pb-2, Pb-3) sequentially become H level, the FETs 51r (51r-1, 51r-2, 51r-3), 51g (51g-1, 51g-2, 51g-3), and 51b (51b-1, 51b-2, 51b-3) are respectively turned on and the LEDs 22r (22r-1, 22r-2, 22r-3), the LEDs 22g (22g-1, 22g-2, 22g-3), and the LEDs 22b (22b-1, 22b-2, 22b-3) are lit.

Moreover, since the sources of the alternate FETs 51r (51r-1, 51r-3), 51g (51g-1, 51g-3), and 51b (51b-1, 51b-3) are connected to the line 54, and sources of the other alternate FETs 51r (51r-2), 51g (51g-2), and 51b (51b-2) are connected to the line 55, a period can be set during which adjacent LEDs light simultaneously.

3. First Example of Power Supply Voltage Control

As described above, in an LED driving circuit 17 such as the one shown in FIG. 3, constant current based on the current setting data from ROM 66 is applied to each of the LEDs 22r (22r-1, 22r-2, 22r-3), the LEDs 22g (22g-1, 22g-2, 22g-3), and the LEDs 22b (22b-1, 22b-2, 22b-3), to drive each LED. At this time, if the output voltage of the power supply circuit 40 is lower than the forward voltage Vf of the respective LEDs, the required constant current cannot be applied to the respective LEDs. Moreover, if the power supply voltage from the power supply circuit 40 is too high, power will be consumed unnecessarily. A preferable output voltage of the power supply circuit 40 is one that is slightly above the forward voltage Vf of the LED.

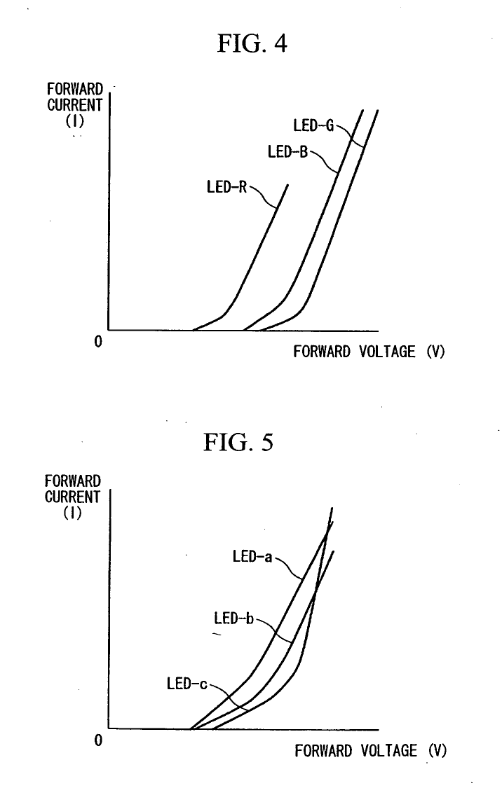

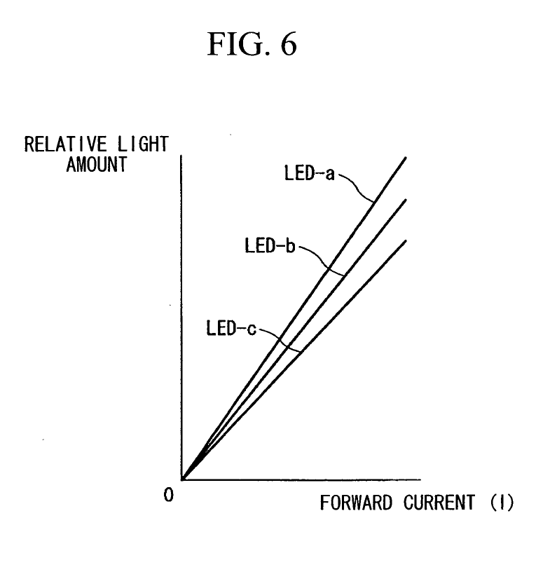

However, the forward voltage Vf of the LED varies depending on the color of the emitted light and individual LEDs. FIG. 4 shows variations in the characteristics of the LEDs of each color. As shown in FIG. 4, there are variations in the characteristics of the red color LED (LED-R), green color LED (LED-G), and blue color LED (LED-B), and the forward voltages Vf differ from color to color. Moreover, FIG. 5 shows variations in LED characteristics within the same color. As shown in FIG. 5, even for LEDs within the same color, there is a variation in the LED characteristics for individual LEDs (LED-a, LED-b, LED-c), and the forward voltages Vf are different. Moreover, FIG. 6 shows variations in light amount characteristics within the same color. As shown in FIG. 6, even for the LEDs of the same color, there is variation in the relative light amount with respect to the forward currents for individual LEDs (LED-a, LED-b, LED-c).

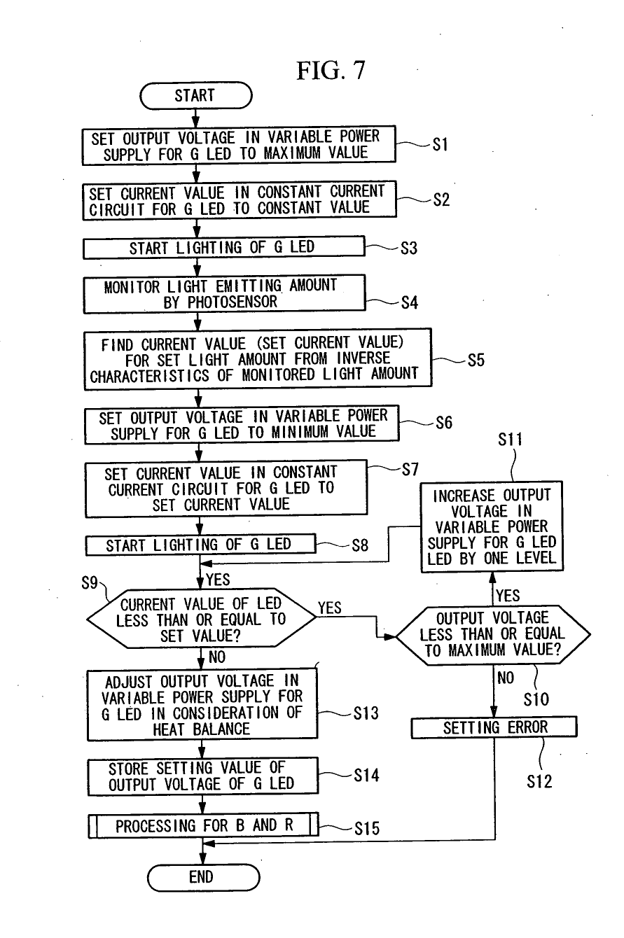

FIG. 7 is a flow chart showing a first example of power supply voltage setting in a projector to which the present invention is applied. In this example, change in the light amount is monitored by the photosensor 71 beforehand, and a constant current value at the time when the required illumination light amount is achieved is found from the inverse characteristics of the change in light amount. Subsequently, the start of irradiation of a predetermined illumination light amount is detected by observing the current value while gradually increasing the voltage value from the power supply circuit 40 from a low voltage value, and detecting that the constant current value, at which the required illumination light amount found from the inverse characteristics from the photosensor 71 is reached, has been reached. The voltage value at the time when it is detected that the predetermined illumination light amount has started to be irradiated is found and taken as a voltage setting value, and a voltage having this voltage setting value is set as an output of the power supply circuit 40 and is supplied to the LED driving circuit.

Moreover, in this example, the output voltage of the power supply circuit is set taking LEDs having substantially equal forward voltage characteristics as a group. That is to say, since the forward voltages Vf of the LEDs of the same color are substantially equal, LEDs of the same color are treated as a group, and the output voltage of the power supply circuit 40 is set for each of the LEDs of each color.

Moreover, as shown in FIG. 4, since the characteristics of the green color LEDs and blue color LEDs are similar, the green color LEDs and blue color LEDs may be treated as a group and the red color LEDs treated as a group, and the output voltages may be set for the two groups.

In FIG. 7, in step S1, the output voltage of the power supply circuit 40 for the green color LEDs is set to a maximum value. The output voltage of the power supply circuit 40 can be changed by the digital potentiometer 49. The output voltage of the power supply circuit 40 at green light emission timing is set to a maximum value by operating this digital potentiometer 49.

In step S2, a current value for green is set to a constant value (step S2). Then in step S3, the constant current of the current value set in step S2 drives and lights the green LED. In step S4, the light emitting amount of the green LED is monitored by the photosensor 71. In step S5, a current value at the time when the light amount characteristics reaches a required value is found from the inverse characteristics of the monitoring result.

In other words, since the output voltage of the power supply circuit 40 has been set to the maximum value for the green LED, the output voltage of the power supply circuit 40 (sufficiently higher than the Vf of the green LED) is sufficiently secured. Then, the current value for the green LED is made to be a constant value in step S2, and the green LED is lit in step S3. The light amount of the green LED at this time is detected by the photosensor 71, and a current at the time when the required light amount characteristics value is reached is found from the inverse characteristics of the detected light amount, and this current value is used as a current setting value. The relationship between the current applied to the LED and the light amount of the LED is stored in the ROM 66.

In the following steps, the output voltage of the power supply circuit 40 is gradually increased from the minimum value while observing the current of the LED, and when it is detected that the current of the LED has exceeded the current setting value, the output voltage of the power supply circuit 40 is set.

In step S6, the output voltage of the power supply circuit 40 for the green LEDs is set to a minimum value. In step S7, the current value for the green LEDs in a constant current circuit is read from the ROM 66 and set as a current setting value. Lighting of the green LEDs is started in step S8, and in step S9, it is determined whether or not the current values of the current applied to all green LEDs in the green light emission period are less than or equal to the current setting value.

At this time, the current value for green in the constant current circuit is set to the current setting value in step S7. However, since the output voltage of the green LED has been set to the minimum value in the power supply circuit 40 in step S6, the output voltage of the power supply circuit 40 becomes less than or equal to the forward voltage, and the current value of the current applied to the green LED becomes less than or equal to the current setting value. Therefore, in step S9, it is determined that the current value of the LED is less than or equal to the setting value.

In step S9, if the current value of the LED is less than or equal to the current setting value, then in step S10 it is determined whether or not the output voltage is less than or equal to the maximum value. If the output voltage is less than or equal to the maximum value, then the output voltage of the power supply circuit 40 for the green LED is raised by one level in step S11. Then processing returns to step S9 and it is determined whether or not the current value of the green LED is less than or equal to the setting value. Moreover, if the output voltage is not less than or equal to the maximum value in step S10, then it becomes a setting error in step S12.

As the loop of step S9 to S11 is repeatedly performed, the power supply voltage of the power supply circuit 40 rises to the forward voltage Vf of the green LED over time, and the current value of the current applied to the green LED becomes greater than or equal to the current setting value.

In step S9, if the current value of the current applied to the green LED exceeds the current setting value, then the output voltage of the power supply circuit 40 is increased or decreased for several levels in consideration of heat balance in step S13, and in step S14 the output voltage of the power supply circuit 40 at this time is stored into the memory 2 as a setting value of the output voltage of the green LED.

When the set voltage for green has been found, output voltage values for red and blue are similarly set in step S15.

Accordingly, in the present embodiment, the driving current of the LED is observed while gradually changing the output voltage of the power supply circuit 40, and the output voltage of the power supply circuit 40 is set. The output voltage of the power supply circuit 40 at the time when the green LED is lit is set according to the set voltage found in this way.

4. Second Example of Power Supply Voltage Control

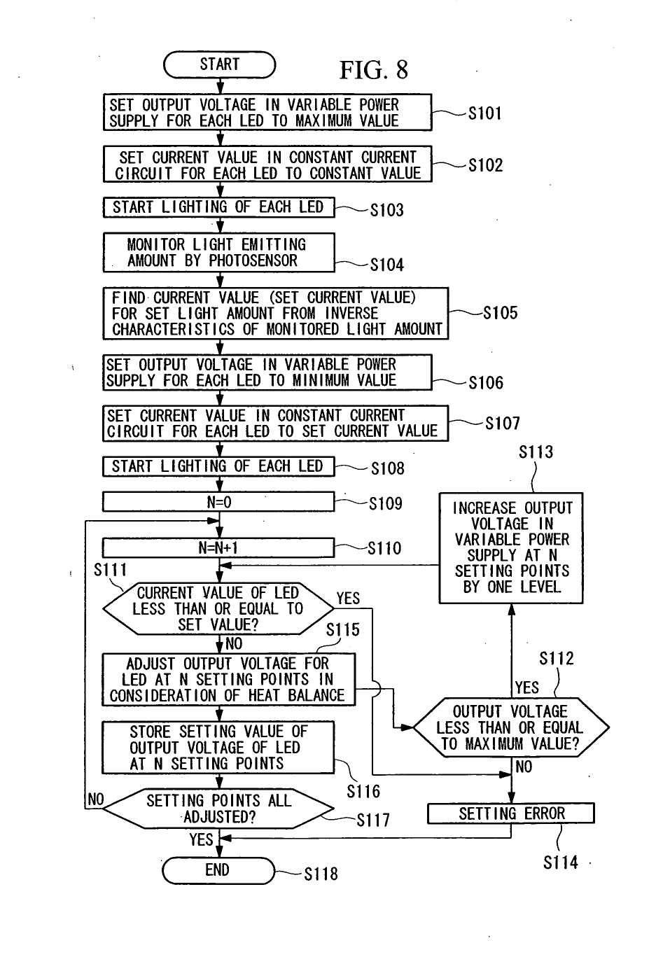

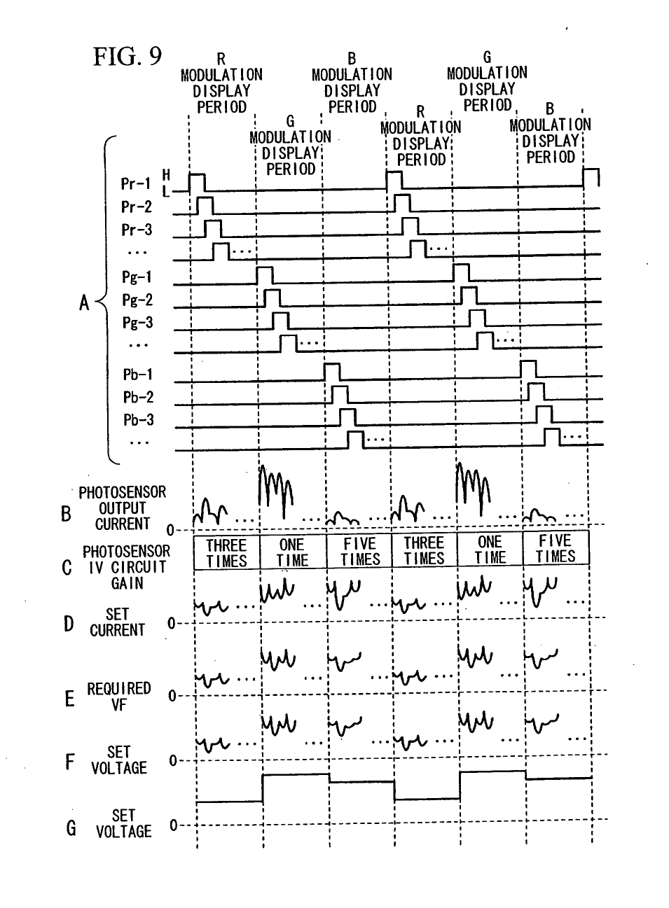

FIG. 8 shows a second example of power supply voltage control. In the first example described above, LEDs of the same color were treated as a group and the output voltage value for the LEDs was set for LEDs of each color. On the other hand, in the present embodiment, the output voltage values of all of the LEDs are set in real time, and the output voltage of the power supply circuit is set for each LED.

In FIG. 8, in step S101, the output voltage of the power supply circuit 40 for each LED is set to a maximum value. In step S102, the current value of each LED is set to a constant value. In step S103, lighting of each LED is started.

In step S104, the light emission amount of each LED is monitored at N points for each of the LED. In step S105, a current value at the time when the light amount setting value is reached is found from the inverse characteristics of the monitoring result from the photosensor 71, and this is set as a current setting value.

In the following steps, at each point the output voltage of the power supply circuit 40 is gradually increased from the minimum value while observing the current of the each LED, and when it is detected that the current of each LED has exceeded the current setting value, the output voltage of the power supply circuit 40 is set.

In step S106, the output voltage of the power supply circuit 40 for each LED is set to a minimum value. In step S107, the current value of each LED is set to a current setting value in the constant current circuit. In step S108, lighting of each LED is started.

In step S109 N is initialized to “0”, in step S110 N is increased in increments of 1, and in step S111 it is determined whether or not the current value of the current applied to each LED is less than or equal to the current setting value at N setting points during the light emitting period of each color.

In step S111, if the current value of the current applied to each LED is less than or equal to the current setting value, then in step S112 it is determined whether or not the output voltage is less than or equal to the maximum value. If the output voltage is less than or equal to the maximum value, then in step S113 the output voltage of the variable power supply of the power supply circuit 40 at N setting points for each LED is raised by one step. Then the process returns to step S111 and it is determined whether or not the current value applied to each LED is less than or equal to the current setting value. Moreover, if the output voltage is not less than or equal to the maximum value in step S112, then it becomes a setting error in step S114.

As the loop of step S111 to S113 is repeatedly performed, the power supply voltage of the power supply circuit 40 rises to the forward voltage Vf of each LED over time, and the current value of the current applied to each LED becomes greater than or equal to the current setting value.

In step S111, if the current value of the current applied to each LED exceeds the current setting value, then the output voltage of the power supply circuit 40 is increased or decreased by several levels in consideration of heat balance in step S115, and in step S116 the output voltage of the power supply circuit 40 at this time is stored into the memory 2 as a setting value of the output voltage of each LED.

In step S117, it is determined whether or not the setting points have all been adjusted. If there still are setting points to be adjusted, then the processing returns to step S110, and if there is no setting points to be adjusted, then the setting finishes.

Accordingly, in the example shown in FIG. 7, LEDs of the same color were treated as a group and the output voltage value for the LEDs was set for LEDs of each color. On the other hand, in the example shown in FIG. 8 , the output voltage values of all of the LEDs are set in real time, and the output voltage of the power supply circuit is set for each LED.

FIG. 9 shows a timing diagram for the case where such power supply voltage control is performed. As shown in A of FIG. 9, when the lighting pulses Pr (Pr-1, Pr-2, Pr-3), Pg (Pg-1, Pg-2, Pg-3), and Pb (Pb-1, Pb-2, Pb-3) are given to the FETs 51r (51r-1, 51r-2, 51r-3), FETs 51g (51g-1, 51g-2, 51g-3), and FETs 51b (51b-1, 51b-2, 51b-3), the FETs 51r (51r-1, 51r-2, 51r-3), FETs 51g (51g-1, 51g-2, 51g-3), and FETs 51b (51b-1, 51b-2, 51b-3) are respectively turned on when the lighting pulses Pr (Pr-1, Pr-2, Pr-3), Pg (Pg-1, Pg-2, Pg-3), and Pb (Pb-1, Pb-2, Pb-3) become H level, and the LEDs 22r (22r-1, 22r-2, 22r-3), the LEDs 22g (22g-1, 22g-2, 22g-3), and the LEDs 22b (22b-1, 22b-2, 22b-3) light. As a result, as shown in B of FIG. 9, the detection output of the photosensor 71 is obtained. Here, the light amount varies within the light emission period of LEDs of the same color because the rotating rod 23 is rotated above the LEDs arranged in a circle to switch the LEDs.

From the inverse characteristics of such a light amount value, a current setting that makes the light amount to be the required amount can be obtained as shown in D of FIG. D. As shown in E of FIG. 9, the forward voltage Vf required for applying the required current is obtained.

As described above, the output voltage of the power supply circuit 40 is gradually raised from the minimum value and set to the output voltage at the time when the current setting shown in D of FIG. 9 was obtained. When as shown in FIG. 7, the output voltage values of the LEDs are set for each color, this set voltage becomes a voltage shown in G of FIG. 9, and when as shown in FIG. 8, the output voltage values of all the LEDs are set in real time, it becomes a voltage shown in F of FIG. 9.

5. Second Example of a Power Supply Control Circuit of a Projector that Uses a Rotating Optical System.

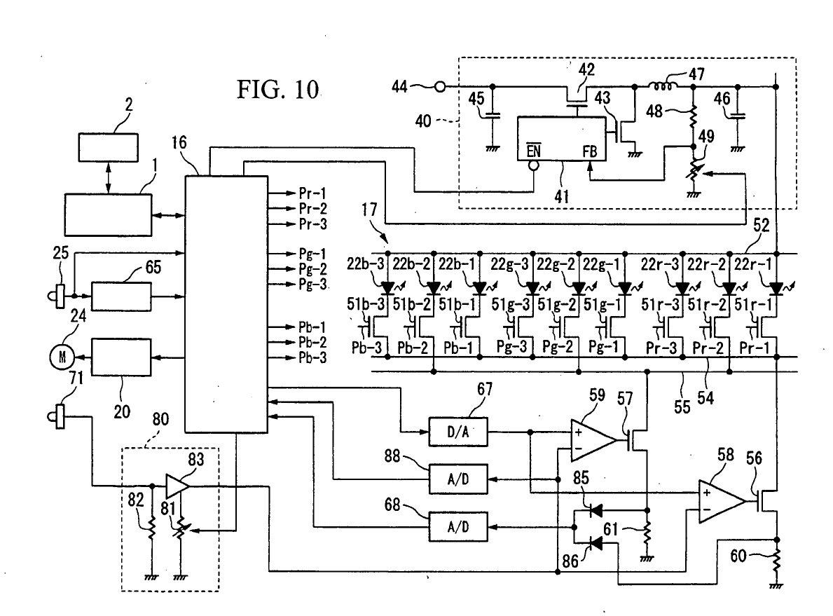

FIG. 10 shows a second example of a power supply control circuit of an LED driving circuit 17 in a projector that uses the above rotating optical system. In this example, the light amount from the LEDs is detected, and a feedback loop is provided for controlling the light emission amount of the LEDs according to the detected light amount.

As shown in FIG. 10, a photosensor 71 detects the light amount of the LED. The detection output of the photosensor 71 is supplied to an IV (current−voltage) conversion circuit 80. The IV conversion circuit 80 converts a detection current of the photosensor 71 into a voltage value. That is to say, a current value is extracted as a voltage value in a resistor 82 of the IV conversion circuit 80. The voltage value of this resistor 82 is outputted via a buffer amplifier 83. The gain of the IV conversion circuit 80 can be set by controlling the gain of the buffer amplifier 83 with a digital potentiometer 81. The output of the IV conversion circuit 80 is supplied to non-inverting input terminals of the operational amplifiers 58 and 59, and is converted into digital data by an A/D converter 88, to be supplied to a timing generation circuit 16.

In such a configuration, when the light amount of the LEDs decreases, the detection output of the photosensor 71 decreases, and the output of the IV conversion circuit 80 decreases. When the output of the IV conversion circuit 80 decreases, the input to the non-inverting input terminals of the operational amplifiers 58 and 59 decreases, and the driving current of the LED increases. As a result, the light amount of the LED increases. Thus, feedback control is performed for the light amount of the LED. The driving current of the LED is detected by resistors 60 and 61 and transmitted to the timing generation circuit 16 via diodes 85 and 86, and the A/D converter 68.

The gain of the IV conversion circuit 80 is controlled for each light emission color. A gain setting signal is supplied from the timing generation circuit 16 to the digital potentiometer 81 of the IV conversion circuit 80 for each light emission period of the LEDs. With this gain setting control signal, the gain of the IV conversion circuit 80 is controlled for each light emission color.

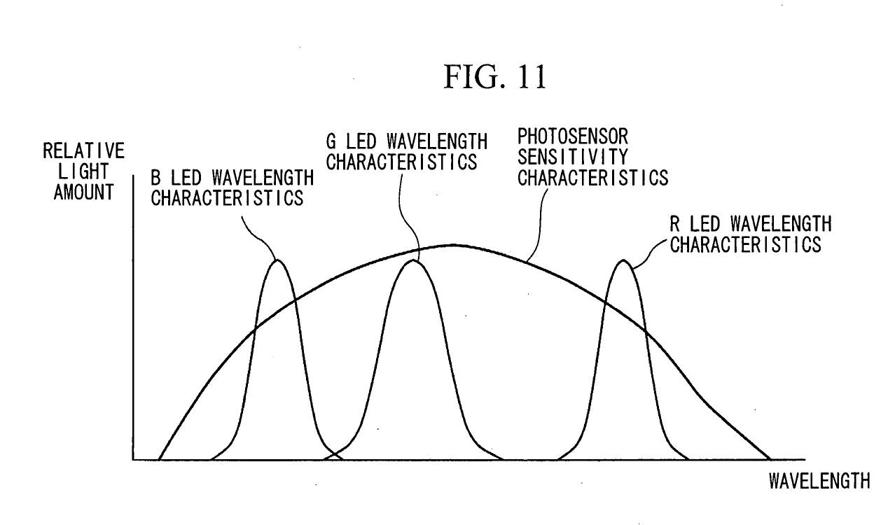

This is because, as shown in FIG. 11, the photosensor 71 is of a single relative luminous efficiency characteristic, and the average value of the current of the LEDs of each color needs to be significantly changed according to wavelength characteristics and a required white balance of the LEDs of each color. For example, the gain of the IV conversion circuit 80 is set to three times in the red color light emission period, and it is set to one time in the green color light emission period, and it is set to five times in the blue light emission period (refer to C of FIG. 9).

6. Third Example of Power Supply Voltage Control

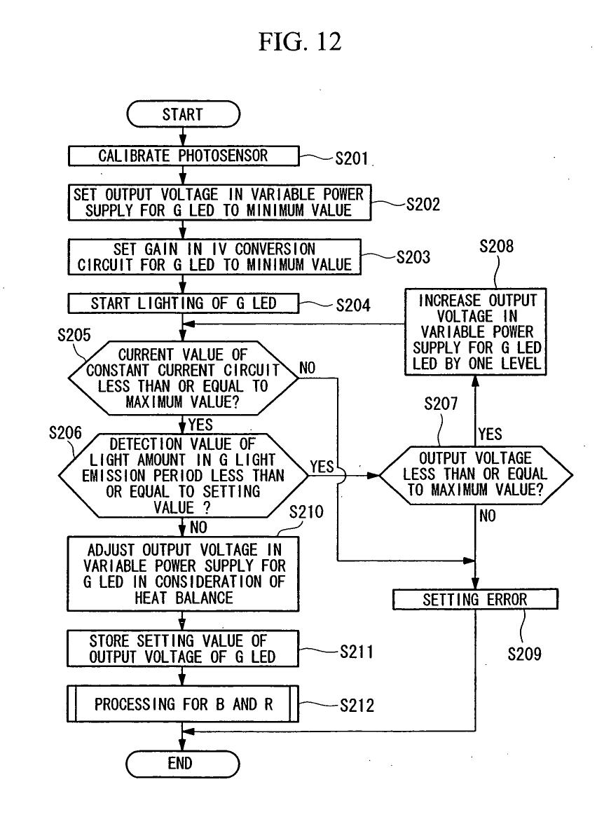

FIG. 12 is a flow chart showing a third example of a power supply voltage setting in a projector to which the present invention is applied. In this example, the LED driving circuit of the feedback control shown in FIG. 10 is used.

In the first and second examples described above, light amount variation is monitored by the photosensor 71 beforehand, and the inverse characteristics of the change in the light amount is taken as an LED driving current value, and the LED driving current is observed while the output voltage of the power supply circuit 40 is gradually raised from the minimum value, to set the voltage of the power supply circuit 40. On the other hand, in this example, the light emission amount of the LED is detected by the photosensor 71, and the light amount of the LED is observed while the output voltage of the power supply circuit 40 is gradually changed, to set the voltage of the power supply circuit 40. Moreover, in this example, the LEDs of each color are treated as a group, and an optimum output voltage of the power supply circuit 40 is set for the LEDs of each color.

In FIG. 12, in step S201, a maximum gain and minimum gain of each light receiving period of the IV conversion circuit 80 are set to calibrate the photosensor 71. In step S202, the output voltage of the power supply circuit 40 when the green LEDs are ON is set to a minimum value. In step S203, the gain of the IV conversion circuit 80 is set to a minimum value for the period during which the light of the green LEDs is received. In step S204, only the green LEDs are lit.

In the following steps, the output voltage of the power supply circuit 40 is gradually increased from the minimum value while observing the current of the LEDs, and when it is detected that the light amount of the LEDs has exceeded the light amount setting value, the output voltage of the power supply circuit 40 is set.

In step S205, it is determined whether or not the current value of the current applied to the LEDs is less than or equal to the maximum value, from the detection value of the A/D converter 68. Since the output voltage of the power supply circuit 40 at the time when the green LEDs are ON has been set to the minimum value in step S202, the current value of the current applied to the green LEDs does not exceed the maximum value. Here, if the current value of the current applied to the green LEDs exceeds the maximum value, then it is processed as a setting error in step S209.

If the driving current does not exceed the maximum value in step S205, then, in step S206, it is determined whether or not the detection value of the light amount of the LEDs from the IV conversion circuit 80 is less than or equal to the setting light amount value in the green light emission period.

In step S206, if the light amount of the LEDs is less than or equal to the light amount setting value, then in step S207, it is determined whether or not the output voltage of the power supply circuit 40 is less than or equal to the maximum value. If the output voltage of the power supply circuit 40 is less than or equal to the maximum value, then in step S208 the output voltage of the power supply circuit 40 when the green LEDs are ON is increased one level, and the processing returns to step S205.

Since the output voltage of the power supply circuit 40 has been set to the minimum value in step S202, then in step S206 the detection value of the light amount of the LEDs is less than or equal to the light amount setting value. In this case, in step 207, it is determined whether or not the output voltage of the power supply circuit 40 when the green LEDs are ON has reached the maximum value, and if it has not reached the maximum value, then in step S208 the output voltage of the power supply circuit 40 is increased in increments of one level.

As the loop of step S205 to S208 is repeatedly performed, the power supply voltage of the power supply circuit 40 rises to the forward voltage Vf of the green LEDs over time, and the light emission amount of the LEDs becomes greater than or equal to the light amount setting value. If the output voltage of the power supply circuit 40 for when the green LEDs are ON has reached the maximum value in step S207, before the light emission amount of the LEDs reaches the light amount setting value, it is processed as an error in step S209.

In step S206, if the detection value of the light amount of the LEDs from the IV conversion circuit 80 exceeds the light amount setting value in the period when the green LEDs are ON, then in step S210 the output voltage of the power supply circuit 40 is increased or decreased by several levels in consideration of heat balance, and in step S211 the output voltage of the power supply circuit 40 at this time is stored into the memory 2 as a setting value of the output voltage of the green LEDs.

When the set voltage for green has been found, output voltage values for red and blue are similarly set in step S212.

Accordingly, in this example, the light amount of the LEDs is observed and the output voltage of the power supply circuit 40 is set, while gradually raising the output voltage of the power supply circuit 40 from the minimum value. The output voltage of the power supply circuit 40 when the LEDs of each color are lit is set according to the set voltage found in this way. 7. Fourth example of power supply voltage control

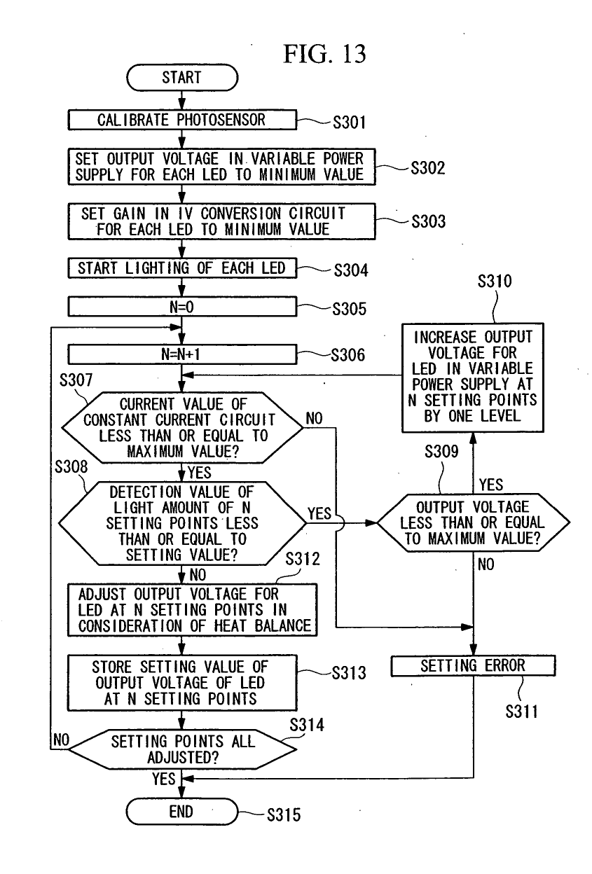

FIG. 13 is a flow chart showing a fourth example of a power supply voltage setting in a projector to which the present invention is applied. In this example, all of the output voltage values of each LED are set in real time, and the output voltage of the power supply circuit is set with respect to each LED. In this example, the LED driving circuit of the feedback control shown in FIG. 10 is used.

In FIG. 13, the photosensor is calibrated in step S301. In step S302, the output voltage of the power supply circuit 40 for each LED is set to a minimum value. In step S303, the gain of the IV conversion circuit 80 is set to a minimum value for the period during which light of each LED is received. In step S304, lighting of each LED is started.

In step S305 N is initialized to “0”, in step S306 N is increased in increments of 1, and in step S307 it is determined whether or not the current value of each LED is less than or equal to the maximum value at N setting points during the light emitting period of each color.

In the following steps, the output voltage of the power supply circuit 40 is gradually increased from the minimum value while observing the light amount of each LED at each point of N points, and when it is detected that the current of the LED has exceeded the current setting value, the output voltage of the power supply circuit 40 is set.

In step S307, if the driving current is less than or equal to the maximum value, then in step S308 it is determined whether or not the detection value of the light amount of the LED from the IV conversion circuit 80 is less than or equal to the setting value at the setting points.

In step S308 if the detected value of the light amount of the LED is less than or equal to the light amount setting value, then in step S309 it is determined whether or not the output voltage of the power supply circuit 40 is less than or equal to the maximum value. If the output voltage of the power supply circuit 40 is less than or equal to the maximum value, then in step S310 the output voltage of the power supply circuit 40 when LEDs of each color are ON is increased one level, and the process returns to step S307.

Since the output voltage of the power supply circuit 40 has been set to the minimum value in step S302, then in step S308 the detection value of the light amount of the LED is less than or equal to the light amount setting value. In this case, in step S309 it is determined whether or not the output voltage of the power supply circuit 40 when the LEDs of each color are ON has reached the maximum value, and if it has not reached the maximum value, then in step S310 the output voltage of the power supply circuit 40 is increased by one level.

As the loop of step S307 to S310 is repeatedly performed, the power supply voltage of the power supply circuit 40 rises to the forward voltage Vf of the LEDs over time, and the light emission amount of the LEDs becomes greater than or equal to the setting value. When the output voltage of the power supply circuit 40 at the time of the setting point, has reached the maximum value in step S309, before the light emission amount of the LEDs reaches the setting value, it is processed as an error in step S311.

In step S308, if the detection value of the light amount of the LED from the IV conversion circuit 80 exceeds the light amount setting value at the setting point, then in step S312 the output voltage of the power supply circuit 40 is increased or decreased by several levels in consideration of the heat balance, and in step S313 the output voltage of the power supply circuit 40 at the setting point is stored into the memory 2 as a light amount setting value of the output voltage of the LED at that setting point.

In step S314, it is determined whether or not the setting points have all been adjusted. If there remain setting points to be adjusted, the processing returns to step S306, and if there remain no setting points to be adjusted, the setting finishes.

8. Resistor Value Setting Using Data

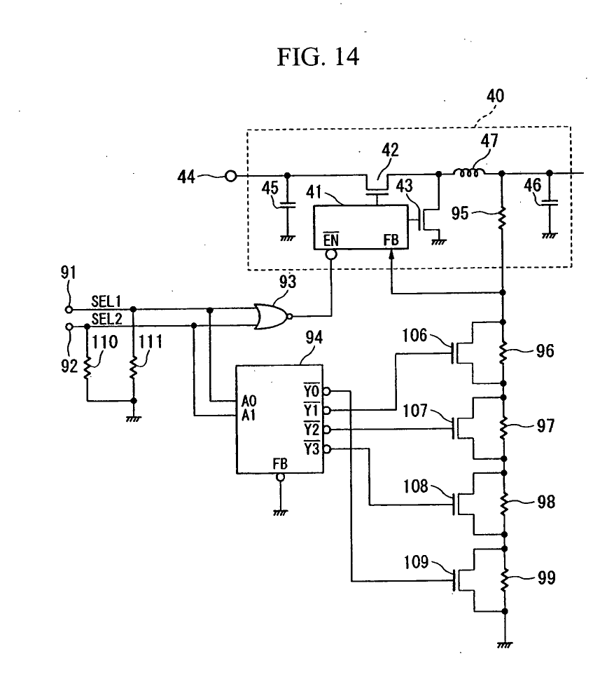

As described above, in the LED driving circuit of a projector that uses a rotating optical system to which the present invention is applied, the power supply circuit 40 with a variable output voltage is used. In the examples of FIG. 3 and FIG. 10, the output voltage of the power supply circuit 40 can be varied using the digital potentiometer 49. However, as shown in FIG. 14, the output voltage may be made variable by decoding a select signal inputted from the control circuit as data, and changing the resistor value of a ladder resistor.

In FIG. 14, 2 bit select signals SEL 1 and SEL 2 are supplied to input terminals 91 and 92. These select signals SEL 1 and SEL 2 are supplied to a NOR gate 93 and supplied to a decoder 94. Resistors 110 and 111 are pull-down resistors.

The NOR gate 93 generates an enable signal for the DC-DC control circuit 41 based on the select signals SEL 1 and SEL 2.

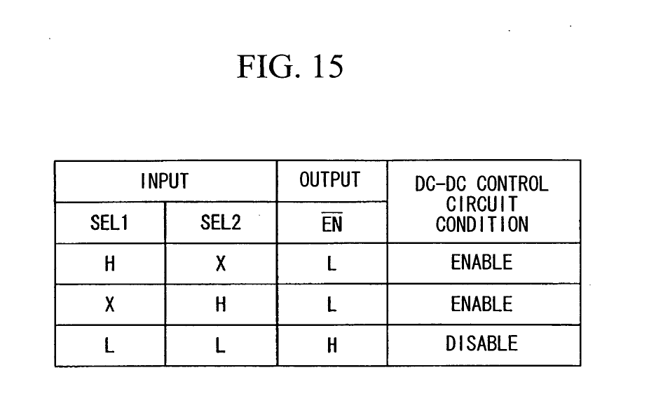

As shown in FIG. 15, when the select signal SEL 1 is H level, the enable signal becomes L level regardless of the select signal SEL 2, and the DC-DC control circuit 41 becomes enabled. Also, when the select signal SEL 2 is H level, the enable signal becomes L level regardless of the select signal SEL 1, and the DC-DC control circuit 41 becomes enabled. When the select signals SEL 1 and SEL 2 are both L level, the enable signal becomes H level, and the DC-DC control circuit 41 becomes disabled.

A ladder resistor comprised of resistors 95 and 99 is connected to the output of the power supply circuit 40. The output of a connection point of the resistor 95 and a resistor 96 is transmitted to the feedback terminal FB of the DC-DC control circuit 41.

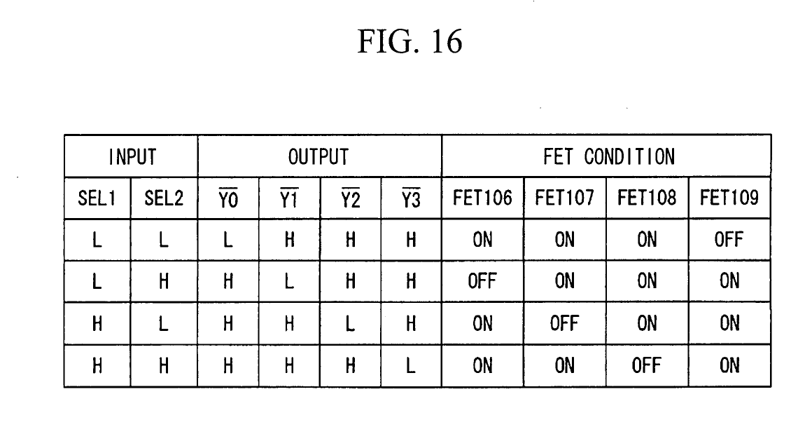

FETs 106 to 109 are respectively connected to the resistors 96 to 99 in parallel. Each output of the decoder 94 is respectively supplied to gates of the FET 106, the FET 107, FET 108, and the FET 109. The output of the decoder 94 is set according to the statuses of the select signals SEL 1 and SEL 2 as shown in FIG. 16. As shown in FIG. 16, the FETs 106 to 109 are turned on and off according to the output of this decoder 94.

As the FETs 106 to 109 are turned on and off, the total resistance values of the resistors 96 to 99 changes. As a result, it becomes equivalent to operating the digital potentiometer 49 in FIG. 4 and FIG. 10.

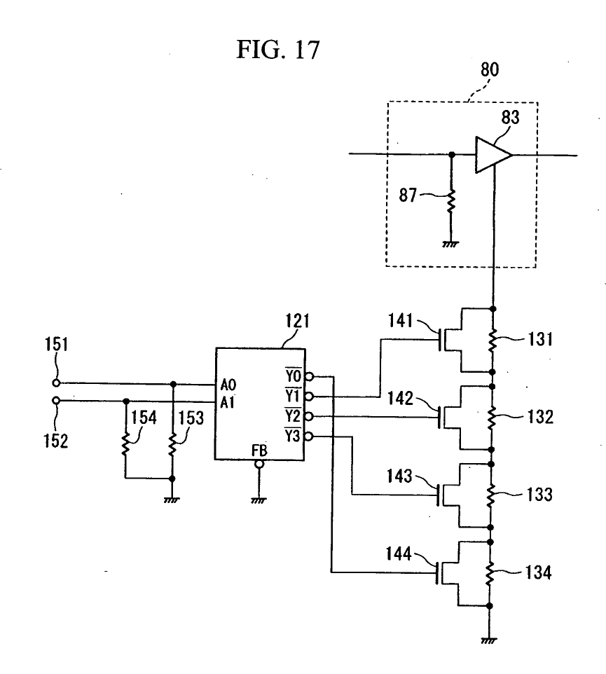

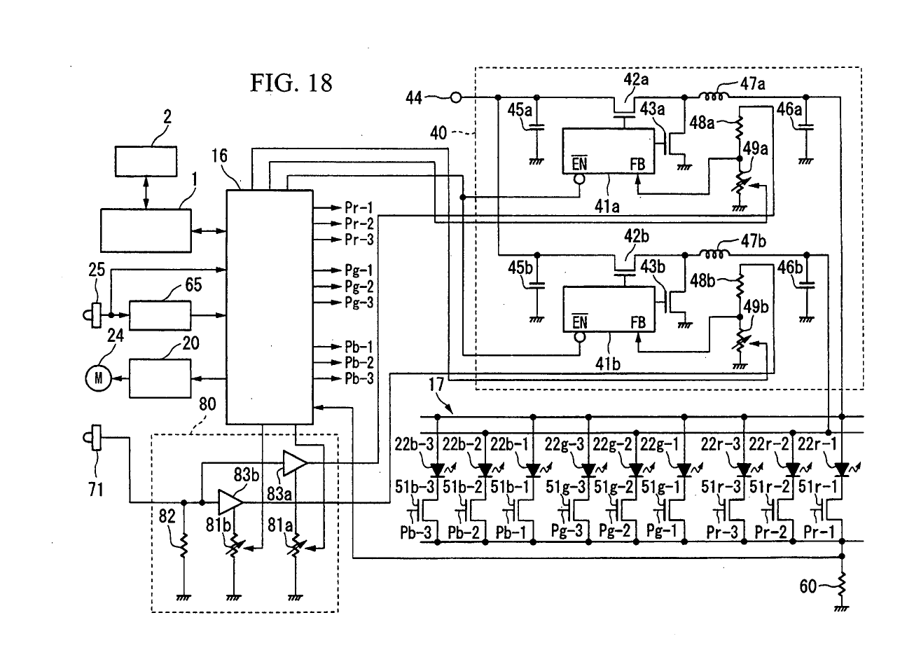

Furthermore, a digital potentiometer 81 in the IV conversion circuit 80 in FIG. 10 may be configured as shown in FIG. 17, with a decoder 121 to which input data is supplied, resistors 131 to 134 connected in series, and FETs 141 to 144 connected to the resistors 131 to 134 in parallel, and when a 2 bit select signal is supplied to input terminals 151 and 152, and the decoder 121 decodes this select signal, and the output of the decoder 121 is supplied to the FETs 141 to 144, and the FETs 141 to 144 are turned on and off by the output of the decoder 121, to change the resistor value. Resistors 153 and 154 are pull-down resistors.

9. Third Example of a Power Supply Control Circuit of a Projector that Uses a Rotating Optical System.

FIG. 18 shows a third example of a power supply control circuit of an LED driving circuit 17. In this example, the detection output of a photosensor 71 directly controls the output voltage of a power supply circuit 40 to control the light amount of the LEDs to be constant.

As shown in FIG. 18, a detection current from the photosensor 71 is extracted at a resistor 82 of an IV conversion circuit 80 as a voltage value, and it is outputted as a voltage value via buffer amplifiers 83a and 83b. The gains of the buffer amplifiers 83a and 83b are set by digital potentiometers 81a and 81b.

The output voltage of the buffer amplifier 83a is taken out from the connection point of a bleeder resistor comprised of resistors 48a and 49a, and is supplied to a feedback terminal FB of a DC-DC control circuit 41a. The output voltage of the buffer amplifier 83b is taken out from the connection point of a bleeder resistor comprised of resistors 48b and 49b, and is supplied to a feedback terminal FB of a DC-DC control circuit 41b.

A driving current with a voltage set by the DC-DC control circuit 41a is applied to the alternate LEDs 22r (22r-1, 22r-3), LEDs 22g (22g-1, 22g-3), and LED 22b (22b-1, 22b-3) , and a driving current with the voltage set by the DC-DC control circuit 41b is applied to the other alternate LED 22r (22r-2), LED 22g (22g-2), and LED 22b (22b-2). As a result, the output voltage of the power supply circuit 40 is controlled according to the detection output of the photosensor 71 and each of the LEDs is lit with the predetermined light amount.

10. Configuration of a Projector that Uses a Fixed Optical System.

The above description up until this point is an application example of a projector that uses a rotating optical system. However, the present invention is not limited to this and can be applied to the case where a fixed optical system is used.

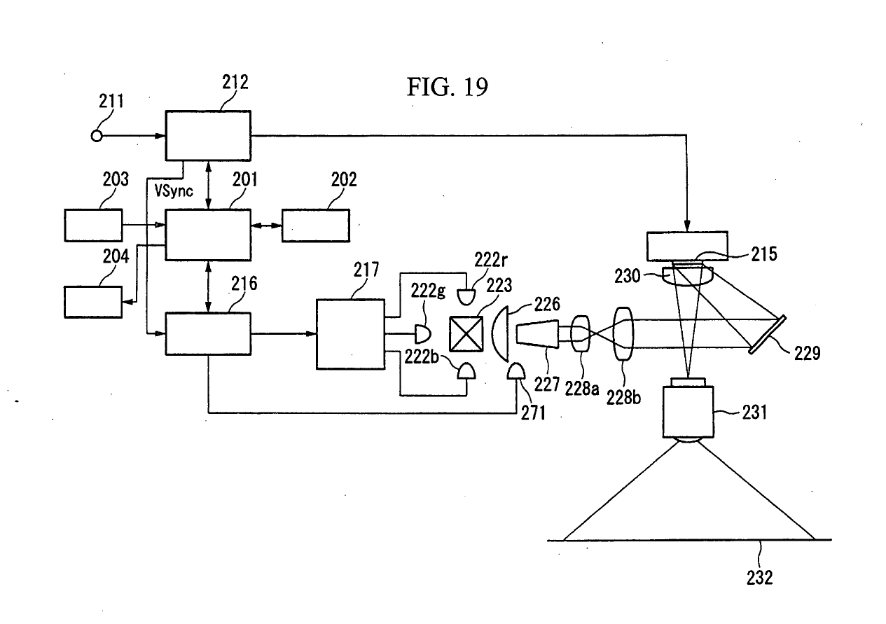

FIG. 19 shows an overall configuration of a projector that uses a fixed optical system. In FIG. 19, a control circuit 201 comprising a CPU (Central Processing Unit) and so forth, controls the overall operations of the projector. The control circuit 201 is connected to a memory 202, an input section 203, and a display section 204.

The input section 203 notifies the control circuit 201 of externally inputted information such as operator operation information, and includes an operation panel, a remote controller, and so forth for performing various kinds of setting. The display section 204 notifies external sections regarding the status of circuits in the device using an LED indicator and the like, according to instructions from the control circuit 201.

An image signal is supplied to an input terminal 211. The image signal from the input terminal 211 is transmitted to a DMD drive control circuit 212. The DMD drive control circuit 212 performs video signal processing such as sync separation, YC separation, IP conversion, resolution conversion, color conversion, and trapezoidal correction, for various kinds of input video signals according to the formats thereof. Here, YC separation refers to processing that separates a luminance signal and a chrominance signal. IP conversion is a conversion from interlace scanning into progressive scanning. The DMD drive control circuit 212 performs conversion processing for a field frequency of the input image signal to prevent color shift, and it further forms an RGB frame sequential image signal based on the input image signal. This frame sequential image signal is supplied as a DMD driving signal to a DMD element 215.

The DMD element 215 is a spatial light modulation element that has a number of minute mirrors disposed on the surface thereof, the angles of the mirrors being changeable with respect to each pixel. When the DMD driving signal from the DMD drive control circuit 212 is given to the DMD element 215, the angles of the minute mirrors on the surface of the DMD element 215 change, thereby changing the path of the light to perform ON/OFF of the light for each pixel.

Moreover, a vertical synchronization signal VSync that has been separated in the DMD drive control circuit 212 is supplied to a timing generation circuit 216. The timing generation circuit 216 generates an LED driving pulse based on a vertical synchronization signal of the input image signal. This LED driving pulse is supplied to an LED driving circuit 217. A driving current is sequentially applied to LEDs 222r, 222g, and 222b from the LED driving circuit 217. As a result, the LEDs 222r, 222g, and 222b light in sequence based on the light emission period of each color.

The lights from the LEDs 222r, 222g, and 222b travel through a dichroic prism 223 and are condensed by a light condensing lens 226, and travel through an illumination optical system comprising a rod integrator 227, illumination lenses 228a, 228b, a mirror 229, and a field lens 230, and are irradiated on a surface of a DMD element 215 on which minute mirrors are formed.

The angles of the minute mirrors on the surface of the DMD element 215 are changed by the DMD driving signal, thereby changing the path of the light. Therefore, the reflected light of the DMD element 215 is modulated by the DMD driving signal from the DMD drive control circuit 212 for each pixel. The light modulated by this DMD driving signal is magnified via a projection lens 231, and is projected on a projection surface 232 as projection light. As a result, an image is projected on the projection surface 232.

11. First Example of a Power Supply Control Circuit of a Fixed Illumination Type Projector.

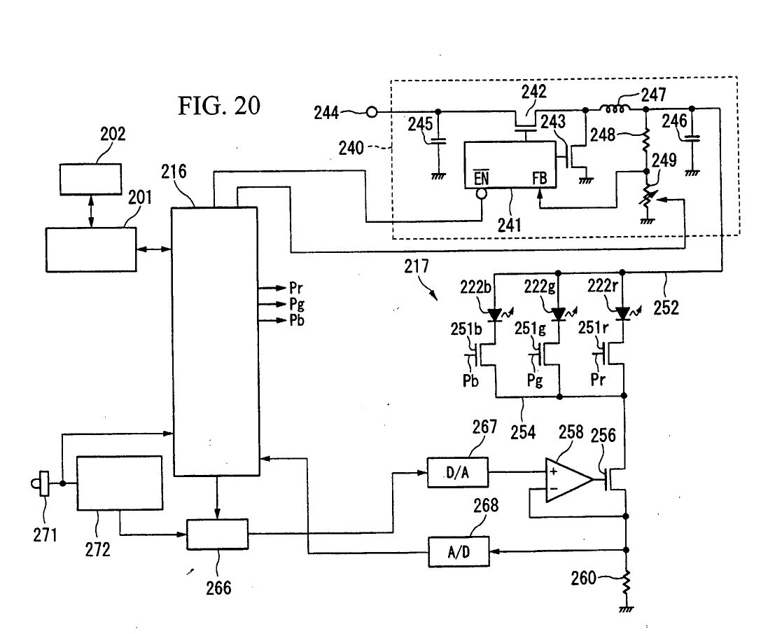

FIG. 20 shows a first example of a power supply control circuit of an LED driving circuit 17 in a projector that uses such a fixed illumination method.

In FIG. 20, a power supply circuit 240 is a constant voltage power supply circuit that comprises a DC-DC control circuit 241. Direct current power is supplied to an input terminal 244, and the power supply from the input terminal 244 is controlled to have a required voltage by the switching operation of a FET242 and a FET 243, and is then transmitted to a power supply line 252.

Capacitors 245 and 246, and a choke coil 247 are for ripple removal. The output voltage of the power supply circuit 240 is detected from a connection point between a resistor 248 and a digital potentiometer 249, and is supplied to a feedback terminal FB of the DC-DC control circuit 241. The DC-DC control circuit 241 switches the FET 242 and the FET 243 based on the feedback voltage transmitted to this feedback terminal FB to control the output voltage to the required voltage.

Moreover, an enable signal from the timing generation circuit 216 is supplied to an enable terminal EN of the DC-DC control circuit 241. When this enable signal reaches L level, the status of the DC-DC control circuit 241 becomes operational.

FETs 251r, 251g, and 251b for switching the respective LEDs are provided for the LEDs 222r, 222g, and 222b. Anodes of the LEDs 222r, 222g, and 222b are connected to a power supply line 252. Cathodes of the LEDs 222r, 222b, 222b are respectively connected to drains of the FETs 251r, 251g, and 251b.

Lighting pulses Pr, Pg, and Pb from the timing generation circuit 216 are respectively supplied to gates of the FETs 251r, 251g, and 251b. The sources of the FETs 251r, 251g, and 251b are connected to a line 254.

The drain of an FET 256 is connected to the line 254. The source of the FET 256 is connected to an inverting input terminal of an operational amplifier 258, and a resistor 260 is connected between the source of the FET 256 and ground.

The timing generation circuit 216 generates lighting pulses Pr, Pg, Pb for each red light emission period, green light emission period, and blue light emission period. Moreover, a ROM 266 outputs data for setting a required driving current for the light emission period of each color. This current value setting data is supplied to a non-inverting input terminal of the operational amplifier 258 via an A/D converter 267.

Within the red color light emission period, the lighting pulse Pr becomes H level, and the FET 251r is turned on. As a result, current flows to the LED 222r, and the LED 222r lights. Within the green color light emission period, the lighting pulse Pg becomes H level, and the FET 251g is turned on. As a result, current flows to the LED 222g, and the LED 222g lights. Within the blue color light emission period, the lighting pulse Pb becomes H level, and the FET 251b is turned on. As a result, current flows to the LED 222b, and the LED 222b lights.

At this time, the current flowing to the LEDs 222r, 222g, and 222b is determined by the current flowing through the FET 256. A set voltage based on the current value setting data read from the ROM 266 is supplied to the non-inverting input terminal of the operational amplifier 258. The output voltage of the operational amplifier 258 is applied to the gate of the FET 255, and the source voltage of the FET 255 is fed-back to an inverting input terminal of the operational amplifier 258. Therefore, a voltage based on the current value setting data is applied to the gate of the FET 256, and the desired current flows to the FET 256. As a result, the desired driving current can be applied to the LEDs 222r, 222g, 222b. LED driving current is detected by the resistor 260, and transmitted to the timing generation circuit 216 via an A/D converter 268.

Even in the case of such a fixed illumination type projector, the output voltage of the power supply circuit 240 needs to be set optimally. In this case, the output voltage of the power supply circuit 240 can be set optimally by performing processing similar to that shown in FIG. 8 or FIG. 9.

12. Second Example of a Power Supply Control Circuit of a Fixed Illumination Type Projector.

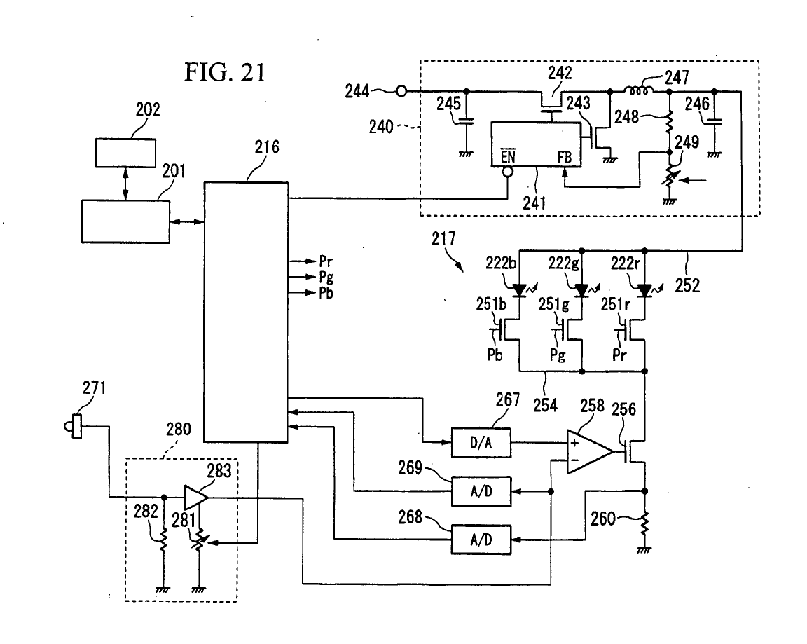

FIG. 21 shows a second example of a power supply control circuit of an LED driving circuit 217 in a projector that uses the above rotating optical system. In this example, the light amount from the LEDs is detected, and a feedback loop is provided for controlling the light emission amount of the LEDs according to the detected light amount.

In FIG. 21, a photosensor 271 monitors a light amount of the LEDs. This light amount detection signal is supplied to an IV conversion circuit 280. The IV conversion circuit 280 converts the output current of the photosensor 271 into a voltage value. That is to say, a current value is taken out as a voltage value by a resistor 282 of the IV conversion circuit 280, and the voltage value of this resistor 282 is outputted via a buffer amplifier 283. The gain of the IV conversion circuit 280 can be set by controlling the gain of the buffer amplifier 283 with a digital potentiometer 281. The output of this IV conversion circuit 280 is supplied to the inverting input terminal of the operational amplifier 258, and is supplied to the timing generation circuit 216 via an A/D converter 269.

As the light amount of the LED decreases, the light amount signal from the photosensor 271 decreases and the output of the IV conversion circuit 280 decreases. As a result, a signal level to the inverting input terminal of the operational amplifier 258 decreases, and the output of the operational amplifier 258 increases. Accordingly, a gate voltage of the FET 256 rises, and the current of the LED increases, and the light amount of the LED increases. As a result, the light amount of the LED is controlled to be the predetermined light amount. In this case, the output voltage of the power supply circuit 240 can be set optimally by performing processing similar to that shown in FIG. 12 or FIG. 13.

13. Third Example of a Power Supply Control Circuit of a Fixed Illumination Type Projector.

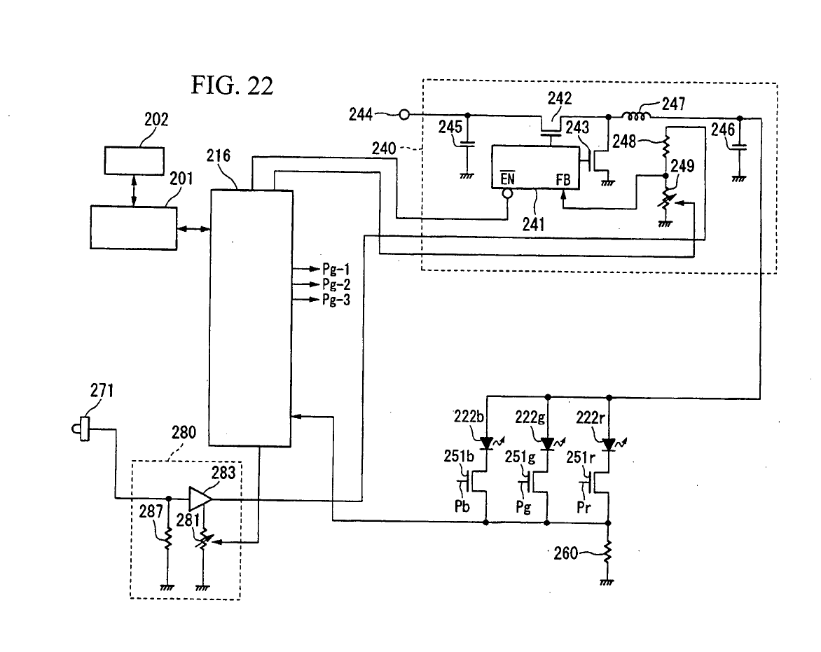

FIG. 22 shows a third example of a power supply control circuit of an LED driving circuit 217 of a fixed illumination type projector. In this example, the detection output of the photosensor 271 directly controls the output voltage of the power supply circuit 240 to control the light amount of the LEDs to the predetermined light amount.

That is to say, as shown in FIG. 21, a detection current from the photosensor 271 is outputted as a voltage value at the IV conversion circuit 280. The output voltage of the buffer amplifier 283 is taken out from the connection point of a bleeder resistor comprised of resistors 248 and 249, and is supplied to a feedback terminal FB of a DC-DC control circuit 241.

A driving current is applied to the LEDs 222r, 222g, and 222b with a voltage set by the DC-DC control circuit 241. As a result, the output voltage of the power supply circuit 240 is controlled and each of the LEDs is lit so that the predetermined light amount is generated, according to the detection output of the photosensor 271.

As described above, in the embodiment of the present invention, the voltage is gradually raised from a low voltage value, and the voltage to be applied to the LED driving circuit is set based on the voltage value at the time when a predetermined current value or predetermined light amount has been achieved. As a result, the LED driving voltage can be set to an optimum voltage value, which is slightly higher that the forward voltage Vf of each LED, and the brightness of the LED can be maintained at an optimum level, and unnecessary power consumption can be prevented.

In the above embodiment, the voltage to be applied to the LED driving circuit is gradually raised from a low voltage value. However, the voltage to be applied to the LED driving circuit may be gradually lowered from a high voltage value to detect a voltage value at the time when the predetermined current value or predetermined light amount value can no longer be attained, and a voltage slightly higher than the voltage value at which the predetermined current value or predetermined light amount value can no longer be attained may be taken as a grounding voltage.

What is claimed is:

1. A light source device comprising;
a plurality of light source sections that output illumination light,
a control section that controls voltage values applied to the plurality of light source sections, and
a light amount monitoring section that detects and monitors whether or not a predetermined illumination light amount is being irradiated from the plurality of light source sections, wherein
the control section gradually increases a voltage value applied to the light source sections from a low voltage value, or gradually decreases a voltage value applied to the light source sections from a high voltage value,
the light amount monitoring section obtains a voltage value at a time when it is detected that a predetermined illumination light amount has started to be irradiated, or at a time when it is detected that a predetermined illumination light amount has ceased to be received, and obtains a voltage setting value based on this voltage value, and
the control section applies a voltage of this voltage setting value to the plurality of light sources.

2. A light source device according to claim 1, wherein the plurality of light source sections comprise a plurality of LEDs.

3. A light source device according to claim 1, wherein the light amount monitoring section separately finds the voltage setting values for each of the plurality of light source sections, and
the control section controls voltage values to be respectively applied to the plurality of light source sections at the separately found voltage setting values.

4. A light source device according to claim 2, wherein the plurality of LEDs have different respective forward voltage characteristics,
and the light amount monitoring section takes LEDs having substantially the same forward voltage characteristics to be a group, and find the voltage setting value for each group,
and the control section controls a voltage value to be applied to the plurality of LEDs based on the voltage setting values found for each group.

5. A light source device according to claim 1, wherein each of the illumination lights irradiated from the plurality of light source sections have a plurality of colors,
and the light amount monitoring section finds the voltage setting value for groups of light source sections having a same color of the irradiated illumination light,
and the control section controls a voltage value to be applied to the plurality of light source sections with the voltage setting values found for each group.

6. A light source device according to claim 1, having a memory section for storing the voltage setting values, wherein, in operation, the control section supplies a voltage of the voltage setting value read from the memory section to the plurality of light sources.

7. A light source device according to claim 1, wherein the light amount monitoring section has a sensor for detecting a light amount value of the illumination light irradiated from the plurality of light source sections, and, based on a light amount value detected by the sensor, the light source section detects whether or not a predetermined illumination light amount has started to be irradiated.

8. A light source device according to claim 7, wherein
the sensor has sensitivity characteristics similar to a relative luminous efficiency of a human being, and has a current-voltage conversion circuit for converting a detected light amount value into a voltage value,
and an amplification factor of the current-voltage conversion circuit changes according to a light emission color from the light source sections.

9. A light source device according to claim 8, wherein
a voltage of the light source sections is controlled based on a voltage value converted from a light amount value detected by the sensor.

10. A light source device according to claim 1, wherein the light amount monitoring section has a second memory section for storing a relationship between a current value applied to the light source sections, and an illumination light amount irradiated from the light source sections, and estimates an illumination light amount corresponding to a detected current value applied to the light source sections, based on the relationship stored in the second memory section.

11. A light source device according to claim 1, having a synthesizing optical section that synthesizes illumination lights irradiated from the plurality of light source sections into one illumination light, and the light amount monitoring section detects whether or not a predetermined illumination light amount has started to be irradiated, based on the light amount of the synthesized illumination light.

12. A projection type display device comprising:
a light source device according to claim 1;
a spatial modulation section; and
a projection optical section.
